(19) United States
(12) Patent Application Publication
(10) Pub. No.: US 2025/0392528 A1
(43) Pub. Date: Dec. 25, 2025

(54) PERFORMANCE MEASUREMENT ON LIVE TRAFFIC TRANSMITTED THROUGH A PACKET-SWITCHED COMMUNICATION NETWORK

(71) Applicant: Telecom Italia S.p.A., Milano (IT)

(72) Inventor: Mauro Cociglio, Torino (IT)

(21) Appl. No.: 18/878,796

(22) PCT Filed: Jun. 21, 2023
(86) PCT No.: PCT/EP2023/066868

§ 371 Date: Dec. 24, 2024

(30) Foreign Application Priority Data
Jun. 24, 2022 (IT) 102022000013417

(51) Int. Cl. H04L 43/022

(52) U.S. Cl. CPC H04L 43/022

(57) ABSTRACT

A method is disclosed for enabling a performance measurement on a multipoint packet flow carrying live traffic through a packet switched communication network. Each packet comprises a marking bit, which before its transmission is set to either a first value indicating that the packet is to be subjected to a sample performance measurement, or a second value indicating that the packet is not to be subjected to a sample performance measurement. A measurement point placed on the path of the packet reads the value of its marking bit and: if it is set to the first value, it generates a sample performance parameter relating to the packet; otherwise, it updates a cumulative performance parameter relating to the multipoint packet flow as a whole. A sample measurement based on the sample performance parameter and/or a multipoint performance measurement based on the cumulative performance parameter may then be performed.

### CROSS-REFERENCE TO RELATED APPLICATION(S)

This Application is a U.S. national stage of PCT/EP2023/066868, filed Jun. 21, 2023, which claims priority to Italian Patent Application no, 102022000013417, filed Jun. 24, 2022, the entire contents of which are incorporated herein by reference.

### TECHNICAL FIELD

The present invention relates to the field of communication networks. In particular, the present invention relates to a method and system for enabling a performance measurement on packets carrying live traffic transmitted through a packet-switched communication network, and to a method and system for performing such performance measurement.

### BACKGROUND ART

In a packet-switched communication network, packet flows are transmitted from source nodes to destination nodes through possible intermediate nodes. Exemplary packet-switched networks are IP (Internet Protocol) networks, Ethernet networks and MPLS (Multi-Protocol Label Switching) networks.

Packets not always reach their destination nodes, i.e. they may be lost during transmission through the network. Packet loss is due to different reasons. For instance, a node or link may fail, or packets may be discarded by a node due to a congestion of its ports. Also, packets may be discarded by a node since they contain bit errors.

Further, each packet is transmitted at a transmission time by the source node and is received at a reception time by the destination node. The time lapsing between transmission time and reception time is typically called “one-way delay”. The one-way delay of a packet mainly depends on the number of possible intermediate nodes crossed by the packet from source to destination, the processing time of the packet by each node and the propagation time along the links.

Furthermore, packets may have different one-way delays. The difference between the one-way delays of two packets of a same packet flow is termed delay variation or “interarrival jitter” (or, briefly, “jitter”).

G. Fioccola et al. “Alternate-Marking Method for Passive and Hybrid Performance Monitoring”, IETF (Internet Engineering Task Force) RFC 8321 January 2018, par. 3.1 discloses a packet loss measurement technique which provides for virtually splitting a traffic flow to be measured into consecutive blocks, counting the number of packets in each block and comparing the values measured by different network devices along the path of the packet flow. In order to create blocks, the packets of the packet flow are “coloured” so that packets of a same block have a same colour, while packets of different consecutive blocks have different colours. Traffic colouring can be implemented by setting a specific bit in the packet header and changing the value of that bit periodically. One-way delay measurements based on a double-marking methodology are also envisaged (par. 3.3.2), which provides for using a first marking to create the alternate flow and, within this coloured flow, a second marking to select the packets for measuring delay/jitter. The second marking creates a new set of marked packets that are fully identified over the network, so that a network device can store the timestamps of these packets.

G. Fioccola et al. “Multipoint Alternate-Marking Method for Passive and Hybrid Performance Monitoring”, IETF (Internet Engineering Task Force) RFC 8889 August 2020 discloses an extension of the alternate marking technique of the above cited RFC 8321, which is applicable to the most general case of a multipoint packet flow. A monitoring network is firstly deduced on the multipoint path of the multipoint packet flow, which is such that all the packets of the multipoint packet flow leaving the monitoring network have previously entered the monitoring network. The packets of the multipoint packet flow transmitted through the monitoring network are subjected to alternate marking. A multipoint packet loss measurement is obtained based on the counts provided by the measurement points of the monitoring network.

In this multipoint scenario, as disclosed by M Cociglio et al. IETF (Internet Engineering Task Force) draft “The Big Data Approach for Multipoint Alternate Marking method draft-c2f-ippm-big-data-alt-mark-01”, Oct. 30, 2020, the packets of the multipoint packet flow to be subjected to multipoint measurement may be identified either by applying an address filtering technique, or by using an additional bit. The default value of such additional bit is 0, while the value 1 is used to identify packets of the traffic flow to be measurement.

### SUMMARY OF THE INVENTION

The Applicant has noticed that, in multipoint scenarios, it may be desirable to provide different types of measurements, including for example delay/jitter measurements on individual packets of a point-to-point packet flow comprised in the multipoint packet flow as provided by the RFC 8321 and a multipoint measurement as provided by the RFC 8889. In this case, if one wishes to avoid use of an address filtering technique to identify the packets of the multipoint packet flow, three different marking bits are required, namely:
a first marking bit to implement an alternate marking of all the packets of the multipoint packet flow, as provided by both the RFC 8321 and the RFC 8889;
a second marking bit to identify, within the point-to-point packet flow, the packets to be individually subjected to delay/jitter measurements according to the RFC 8321; and
a third marking bit to identify the packets of the multipoint packet flow to be subjected to the multipoint measurement according to the RFC 8889.

FIG. 1 schematically depicts the values of such three marking bits in the packets of such point-to-point packet flow according to the provisions of the RFC 8321 and RFC 8889.

The first bit B1 is periodically switched with a period T (also termed herein after “marking period”) between 1 and 0, so as to implement an alternate marking technique whereby traffic is divided into alternate blocks BL1, BL2, BL3, BL4, . . . of duration T, as provided by both the RFC 8321 and the RFC 8889. The second bit B2 is equal to 0, except for a single packet per marking period (for example, the first packet of each block BL1, BL2, BL3, BL4, . . . ) to be subjected to delay/jitter measurements according to the RFC 8321. For those packets only, the second marking bit B2 is equal to 1. The third marking bit B3 is always equal to 1, to indicate that all the packets belong to the multipoint packet flow and are therefore to be considered for a multipoint measurement according to the RFC 8889. Packets not belonging to the multipoint packet flow, which are to be disregarded (not depicted in FIG. 1), instead have the third marking bit B3 equal to the default value 0.

While the above marking scheme would be capable of supporting all the desired measurements, the Applicant has noticed that, currently, two bits only are available in the packet's header to implement a marking of the packets which supports passive performance measurements (namely, performance measurements carried out on live traffic, without requiring to actively inject into live traffic any special packet dedicated to measurement purposes).

In view of the above, the Applicant has tackled the problem of providing a method and system for enabling a performance measurement on a multipoint packet flow carrying live traffic through a packet-switched communication network, which is based on an alternate marking technique and which is capable of enabling both a sample performance measurement on packets of a point-to-point packet flow of the multipoint packet flow and a multipoint performance measurement on the multipoint packet flow as a whole, by using two bits only and without requiring the application of any address filtering technique to identify the packets to be considered for the multipoint measurement.

In the present description and in the claims, the expression “sample performance measurement” will designate a performance measurement relating to a specific packet (e.g. its one-way delay, such as for example, but not exclusively, a delay measurement as provided by the RFC 8321) or a sequence of specific packets within a packet flow (e.g. their delay variation or jitter such as for example, but not exclusively, a jitter measurement as provided by the RFC 8321). The expression “multipoint performance measurement” will instead indicate a performance measurement relating to a multipoint packet flow as a whole (e.g. its packet loss or average one-way delay, for example, but not exclusively, as provided by the RFC 8889), where “multipoint packet flow” indicates a packet flow whose packets follow at least partially non-overlapping paths. Further, the expression “enabling a performance measurement” will indicate an operation of providing or generating performance parameters (such as timestamps or counters) which a node of the network or an external entity (such as a management server gathering the performance parameters from the nodes of the network) may use to calculate the performance measurement.

According to embodiments of the present invention, the above problem is solved by a method and system wherein the value of the first marking bit B1 is alternately switched between two alternative marking values (e.g. 1 and 0). As to the second marking bit B2, it is set to either a first marking value (also termed herein after “sampling value”, e.g. 0) indicating that the packet is to be subjected to a sample performance measurement, or to a second marking value (also termed herein after “non-sampling value”, e.g. 1) indicating that the packet is not to be subjected to a sample performance measurement. One or more measurement points placed on the path of the marked packets read the second marking bit B2 of the received packets. If the second marking bit B2 is set to the sampling value, the measurement point determines that the packet is to be subjected to a sample performance measurement and then generates a sample performance parameter relating to that packet (e.g. a timestamp). Otherwise, if the second marking bit B2 is set to the non-sampling value, the measurement point determines that the packet is to be considered for the multipoint measurement, and accordingly updates a cumulative performance parameter relating to the multipoint packet flow as a whole (e.g. a cumulative counter). A performance measurement is thus enabled, which includes a sample measurement based on the sample performance parameter and/or a multipoint performance measurement based on the cumulative performance parameter.

The packets to be individually subjected to a sample measurement and the packets to be considered for the multipoint measurement are therefore identified based on different values 0 or 1 of the same bit, namely the second marking bit B2. Hence, the packets to be considered for the multipoint measurement can be identified without applying any address filtering technique and without requiring any additional bit dedicated for this purpose. Since the second marking bit B2 merges two separate functions, two bits only are then needed to support all the requested performance measurements based on alternate marking, namely the sample measurement (for example, a delay or jitter measurement as provided by the RFC 8321) and the multipoint measurement (for example, the multipoint measurement as provided by the RFC 8889).

It shall be noticed that, in general, in order to perform a sample measurement on a point-to-point packet flow, few packets are needed, typically one per marking period T at most. Hence, even assuming that sample measurements are required on all the point-to-point packet flows of the multipoint packet flow, the large majority of the packets of the multipoint packet flow still have their second marking bit B2 set equal to the non-sampling value. This advantageously results in the multipoint measurement being based on the large majority of the packets of the multipoint packet flow. An accurate multipoint measurement may accordingly be provided.

According to a first aspect, the present invention provides a method for enabling a performance measurement on a multipoint packet flow carrying live traffic through a packet switched communication network, each packet of the multipoint packet flow comprising a first marking bit and a second marking bit, the method comprising:
a) before transmitting each packet of the multipoint packet flow through the network, alternately switching the value of the first marking bit between two alternative marking values; and setting the second marking bit to either a first value indicating that the packet is to be subjected to a sample performance measurement or a second value indicating that the packet is not to be subjected to the sample performance measurement; and
b) at at least one measurement point placed on the path of the packet reading the second marking bit and:
   if the second marking bit is set to the first value, generating a sample performance parameter relating to the packet; and
   if the second marking bit is set to the second value, updating a cumulative performance parameter relating to the multipoint packet flow as a whole.

Preferably, at step a) the two alternative marking values are equal to the first value indicating that the packet is to be subjected to a sample performance measurement and the second value indicating that the packet is not to be subjected to the sample performance measurement.

More preferably, the first value indicating that the packet is to be subjected to a sample performance measurement is 0, and the second value indicating that the packet is not to be subjected to the sample performance measurement is 1.

According to an embodiment, at step a) the second marking bit is set equal to the first value indicating that the packet is to be subjected to a sample performance measurement in at least one packet of a point-to-point packet flow comprised in the multipoint packet flow, the other packets of the point-to-point packet flow having said second marking bit set equal to the second value indicating that the packet is not to be subjected to the sample performance measurement.

Preferably, at step a) the method comprises, before transmitting each packet of the multipoint packet flow through the network, periodically switching the value of the first marking bit between two alternative marking values with a marking period T.

Preferably, at step a) the second marking bit is set equal to the first value indicating that the packet is to be subjected to a sample performance measurement in one packet of the point-to-point packet flow per marking period T.

According to a variant, at step a) the second marking bit is set equal to the first value indicating that the packet is to be subjected to a sample performance measurement in one packet of the point-to-point packet flow per marking period T, only if the first marking bit during the marking period T is set equal to a predefined one of the two alternative marking values.

Preferably, the predefined one of the two alternative marking values is equal to the second value indicating that the packet is not to be subjected to the sample performance measurement.

According to some embodiments, step b) comprises updating the cumulative performance parameter relating to the multipoint packet flow as a whole also if the second marking bit is set to the first value indicating that the packet is to be subjected to a sample performance measurement and the first marking bit is equal to the second value indicating that the packet is not to be subjected to the sample performance measurement.

According to a variant, the method further comprises exchanging the first value indicating that the packet is to be subjected to a sample performance measurement and the second value indicating that the packet is not to be subjected to the sample performance measurement periodically according to the marking period T.

Preferably, the sample performance parameter relating to the packet comprises a timestamp indicating a reception time of the packet at the at least one measurement point.

Preferably, the cumulative performance parameter comprises a cumulative counter counting packets of the multipoint packet flow received at the at least one measurement point and/or a cumulative or average timestamp indicative a cumulative or average reception time of packets of the multipoint packet flow at the at least one measurement point.

According to an embodiment, at step b) the at least one measurement point determines whether the packet belongs to a point-to-point packet flow for which the sample performance measurement is required by applying an access command list technique.

According to an embodiment, at step a) the multipoint packet flow is injected in the network via at least two source nodes, periodically switching the value of the first marking bit being performed by the at least two source nodes in a substantially synchronized way.

According to a second aspect, the present invention provides a method for performing a performance measurement in a packet-switched communication network, the method comprising the steps of the method for enabling a performance measurement as set forth above and:
c) performing a performance measurement including at least one of a sample measurement relating to the packet based on the sample performance parameter and a multipoint performance measurement based on the cumulative performance parameter.

Optionally, step b) further comprises sending at least one of the sample performance parameter and cumulative performance parameter to a management server cooperating with the at least one measurement point, step c) being performed by the management server.

According to a third aspect, the present invention provides a packet switched communication network supporting transmission of a multipoint packet flow carrying live traffic, each packet of the multipoint packet flow comprising a first marking bit and a second marking bit, the packet switched communication network comprising:
a) at least one node configured to, before transmitting each packet of the multipoint packet flow through the network, alternately switch the value of the first marking bit between two alternative marking values; and set the second marking bit to either a first value indicating that the packet is to be subjected to a sample performance measurement or a second value indicating that the packet is not to be subjected to the sample performance measurement; and
b) at least one measurement point placed on the path of the packet, the at least one measurement point being configured to read the second marking bit and:
   if the second marking bit is set to the first value, generate a sample performance parameter relating to the packet; and
   if the second marking bit is set to the second value, update a cumulative performance parameter relating to the multipoint packet flow as a whole.

Preferably the packet switched communication network further comprises:
c) a management server configured to perform a performance measurement including at least one of a sample measurement relating to the packet based on the sample performance parameter and a multipoint performance measurement based on the cumulative performance parameter.

### BRIEF DESCRIPTION OF THE DRAWINGS

The present invention will become clearer from the following detailed description, given by way of example and not of limitation, to be read with reference to the accompanying drawings, wherein:

FIG. 1 (already described above) shows the known marking scheme provided by the RFC 8321 and RFC 8889;

FIG. 2 schematically shows an exemplary network supporting transmission of a multipoint packet flow in which the method for performing performance measurements according to embodiments of the present invention is implemented;

FIGS. 3A, 3B, and 3C schematically show alternative networks supporting transmission of other multipoint packet flows;

FIG. 4 schematically shows the structure of a packet exchanged in the communication network of FIG. 1, according to embodiments of the present invention;

FIG. 5 shows a marking scheme based on two marking bits, according to an embodiment of the present invention;

FIG. 6 is a flow chart of the operation of a measurement point, according to an embodiment of the present invention;

FIG. 7 is a flow chart of the operation of a measurement point, according to another embodiment of the present invention;

FIG. 8 shows a marking scheme based on two marking bits, according to another embodiment of the present invention; and

FIGS. 9 and 10 show marking schemes based on two marking bits, according to still other embodiments of the present invention.

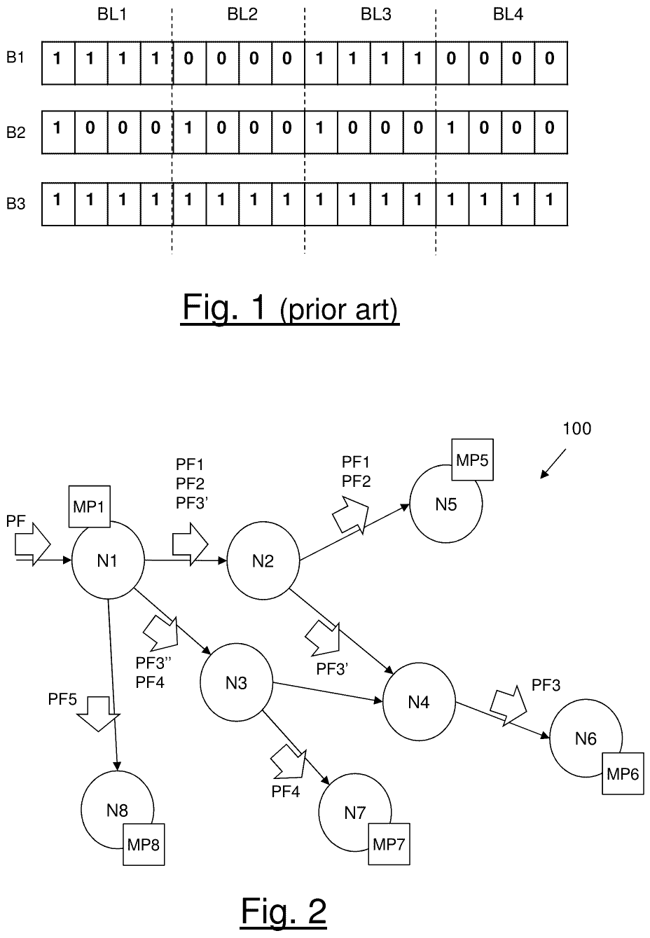

### DETAILED DESCRIPTION OF PREFERRED EMBODIMENTS OF THE INVENTION

FIG. 2 schematically shows an exemplary network 100 supporting transmission of a multipoint packet flow PF, in which the method for enabling a performance measurement according to embodiments of the present invention is implemented. The network 100 may be an IP network or any other type of packet-switched network (e.g. MPLS or Ethernet).

The network 100 comprises a plurality of nodes reciprocally interconnected by links according to any known topology. By way of non-limiting example, the network 100 comprises eight nodes N1, N2, . . . . N8 reciprocally interconnected according to a partially meshed topology. In particular, node N1 is connected to N2, N3 and N8, node N2 is connected to N4 and N5, node N3 is connected to N4 and N7, node N4 is connected to N6.

The network 100 supports transmission of a multipoint packet flow PF. The multipoint packet flow PF comprises K point-to-point packet flows.

The K point-to-point packet flows may be originated by N=1 source node and addressed to M>1 destination nodes. This is the case of the exemplary scenario depicted in FIG. 2, where the packet flow PF comprises K=5 point-to-point packet flows PF1, PF2, . . . . PF5 having N=1 source node N1 and M=4 destination nodes N5, N6, N7 and N8. In particular, PF1 and PF2 are addressed to N5, PF3 is addressed to N6, PF4 is addressed to N7 and PF5 is addressed to N8. The multipoint packet flow PF as a whole is injected in the network 100 via the source node N1 and is then split. In particular, by way of non-limiting example, PF1, PF2 and first portion PF3′ of the packet flow PF3 are transmitted by N1 to N2, while another portion PF3″ of the packet flow PF3 together with PF4 are transmitted from N1 to N3 and PF5 is transmitted to N8. At the node N2, PF1, PF2 and the first portion PF3′ of the packet flow PF3 are further split, namely PF1 and PF2 are transmitted to N5, while PF3′ is transmitted to N4. At the node N3, PF3″ and PF4 are further split, namely PF3″ is transmitted to N4, while PF4 is transmitted to N7. At the node N4, the portions PF3′ and PF3″ are joined and forwarded to N6.

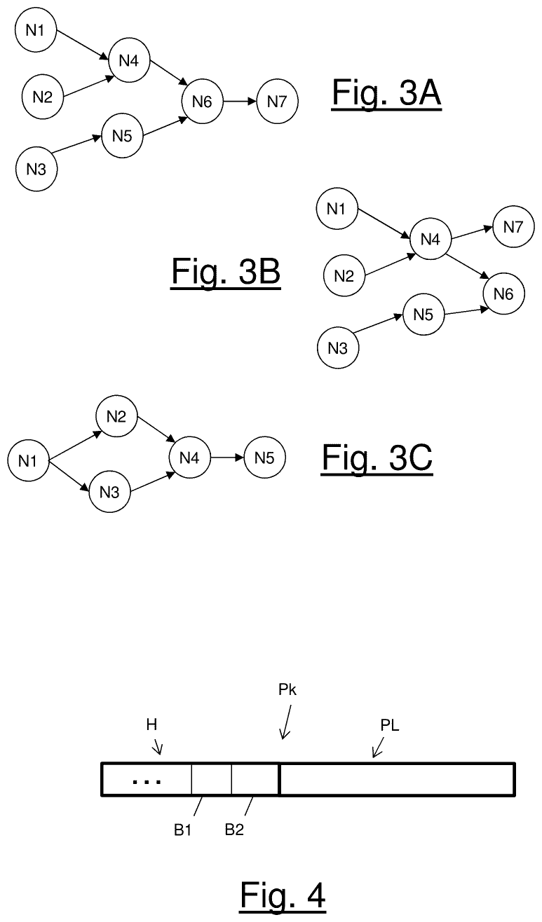

Alternatively, the multipoint packet flow PF may have N>1 source nodes and M=1 destination node. This is the case of the exemplary scenario depicted in FIG. 3A, where nodes N1, N2, N3 are three source nodes and N7 is the unique destination node.

Alternatively, the multipoint packet flow PF may have N>1 source nodes and M>1 destination nodes. This is the case of the exemplary scenario depicted in FIG. 3B, where nodes N1, N2, N3 are three source nodes, while N6 and N7 are two destination nodes. In this case, the multipoint packet flow PF may have few source nodes and several destination nodes, namely N<<M. This is the case e.g. of multipoint packet flows carrying traffic of an OTT internet service in the downstream direction, namely from few OTT servers to multiple end users, or those carrying LTE (Long Term Evolution) traffic in the downstream direction, namely from few packet gateways to several eNodeBs. Alternatively, the multipoint packet flow PF may have several source nodes and few destination nodes, namely N>>M. This is the case e.g. of multipoint packet flows carrying traffic of an OTT internet service in the upstream direction, namely from multiple end users to few OTT servers, or those carrying LTE traffic in the upstream direction, namely from several eNodeBs to few packet gateways.

Alternatively, the multipoint packet flow PF may have N=1 source node and M=1 destination node but follow different paths through the network 100. This is the case of the exemplary scenario depicted in FIG. 3C, where N1 is the unique source node and N5 is the unique destination node.

Preferably, as schematically depicted in FIG. 4, each packet Pk of the multipoint packet flow PF comprises a header H and a payload PL. The payload PL comprises user data. Preferably, the header H comprises information for routing the packet Pk. The header format depends on the protocol according to which the packets Pk are formatted.

According to preferred embodiments of the present invention, the packets of the multipoint packet flow PF are marked before they are injected in the network 100 via the respective source node(s). The marking may be implemented at the source node(s) through which the K point-to-point packet flows comprised in the multipoint packet flow PF are injected in the network 100, or upstream the source node(s).

More particularly, each packet Pk of the multipoint packet flow PF comprises a first marking bit B1 and a second marking bit B2, as schematically depicted in FIG. 4. The value of each marking bit B1, B2 may be set to any of two alternative marking values, namely 1 and 0. The marking bits B1, B2 are preferably comprised in the packet header H.

Preferably, in the packets Pk of the K point-to-point packet flows of the multipoint packet flow PF, the value of the first marking bit B1 is alternately switched between two alternative marking values (e.g. 1 and 0). More preferably, the value of the first marking bit B1 is periodically switched between the two alternative marking values (e.g. 1 and 0) with a period T, which will be termed herein after “marking period”. The marking period T may be set by the network operator, according to the desired time measurement rate (as it will be described in detail herein after, the marking period T is also the measurement period). For instance, the marking period T may be equal to 5 minutes.

The switching of the value of the first marking bit B1 for all the K point-to-point packet flows of the multipoint packet flow PF is substantially synchronized, namely the switching is performed substantially at the same time (namely, with a maximum mismatch of T/2) for all the K point-to-point packet flows of the multipoint packet flow PF. This way, the packets Pk of the multipoint packet flow PF which are transmitted during a certain marking period through the network 100 have their first marking bit B1 set substantially to a same marking value 1 or 0.

As to the second marking bit B2, its value is preferably set equal to either a marking value (also termed “sampling value”, e.g. 0) indicating that the packet Pk is to be subjected to a sample measurement, or a marking value (also termed “non-sampling value”, e.g. 1) indicating that the packet Pk is not to be subjected to a sample measurement.

According to a first embodiment, in the packets Pk of each point-to-point packet flow PF1, PF2, . . . . PF5 on which sample measurements are required, the second marking bit B2 is preferably set to the non-sampling value for all the packets Pk, except one packet Pk per each marking period T, whose second bit B2 is set equal to the sampling value. Preferably, only one packet Pk per marking period T has its second bit B2 set to the sampling value. According to some variants, however, two or more packets Pk per sampling period T may have their second bit B2 set to the sampling value.

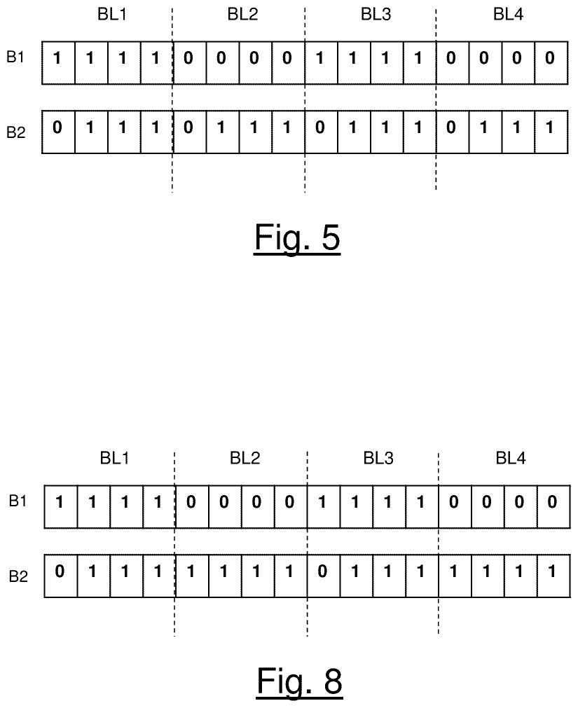

FIG. 5 schematically shows the values of the first marking bit B1 and second marking bit B2 in the packets of a point-to-point packet flow comprised in the multipoint packet flow PF for which sample measurements are required, according to the first embodiment of the present invention.

The first marking bit B1 is periodically switched with a marking period T between 1 and 0, so as to implement an alternate marking technique whereby traffic is divided into alternate blocks BL1, BL2, BL3, BL4, . . . of duration T, as provided by both RFC 8321 and RFC 8889. The second bit B2 is equal to the non-sampling value 1 for all the packets Pk, except for one packet per marking period (by way of non-limiting example, the first packet of each block BL1, BL2, BL3, BL4, . . . ). For those packets Pk only, the second marking bit B2 is set equal to the sampling value 0.

For the point-to-point packet flows of the multipoint packet flow PF for which no sample measurements are required, the second marking bit B2 of the packets Pk is instead fixedly equal to the non-sampling value (e.g. 1).

Preferably, a monitoring network is implemented on the path of the packets Pk of the multipoint packet flow PF marked as described above. The monitoring network comprises at least one measurement point implemented on the path of the packets Pk of the multipoint packet flow PF marked as described above. More preferably, the monitoring network comprises at least two measurement points implemented on the path of the packets Pk of the multipoint packet flow PF marked as described above. Each measurement point may be either embedded within a respective node, or implemented as a stand-alone machine connected to a respective node.

In order to enable a multipoint measurement on the multipoint packet flow PF, the measurement points of the monitoring network are preferably arranged to form a cluster, a cluster being defined as a set of measurement points which exhibits the property that the ensemble of the packets Pk of the multipoint packet flow PF received at the input measurement point(s) of the cluster is the same as the ensemble of the packets Pk of the multipoint packet flow PF received at the output measurement point(s) of the cluster, if no packet loss occurs. In other words, if no packet loss occurs, each packet Pk of the multipoint packet flow PF received by anyone of the cluster input measurement points is also received at one of the cluster output measurement points.

A cluster for example may comprise an input measurement point at each one of the N source nodes and an output measurement point at each one of the M destination nodes of the multipoint packet flow PF. This is shown in FIG. 2, where a measurement point MP1 is implemented at the source node N1 and measurement points MP5, MP6, MP7, MP8 are implemented at the destination nodes N5, N6, N7, N8.

If one or more measurement points are implemented at the intermediate nodes of the network 100 (not shown in FIG. 2), other clusters of measurement points may be defined, as described by EP3449602 in the name of the same Applicant.

Preferably, the monitoring network is also provided with a management server, which is not shown in FIG. 2 for simplicity. The management server may be a stand-alone server connected to any of the nodes. Alternatively, the management server may be implemented at any of the nodes. The management server preferably cooperates with the measurement points for gathering therefrom performance parameters, as it will be described in detail herein after.

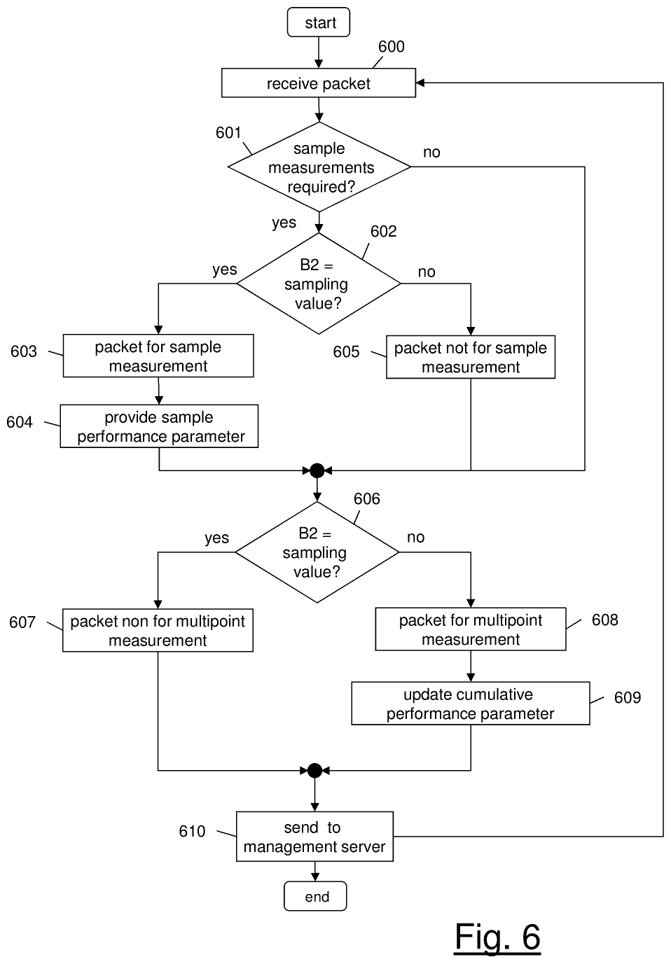

Each measurement point of the monitoring network is preferably configured to provide performance parameters relating to the packets Pk of the multipoint packet flow PF so as to enable a performance measurement including at least one of a sample performance measurement on individual packets Pk of at least one of the point-to-point packet flows PF1, PF2, . . . . PF5 and a multipoint performance measurement on the multipoint packet flow PF as a whole, as it will be described in detail herein after with reference to the flow chart of FIG. 6.

Each measurement point MPi (i=1, 2, . . . 8) receives all the traffic (or a copy thereof) received at the node at which it is implemented or connected (step 600).

For each received packet Pk, the measurement point MPi first of all determines whether the packet Pk belongs to a point-to-point packet flow for which sample measurements are required (step 601). In order to perform step 601, the measurement point MPi preferably applies an ACL (Access Command List) technique.

If the packet Pk belongs to a point-to-point packet flow for which sample measurements are required, the measurement point MPi preferably determines whether the packet Pk is to be subjected to a sample measurement based on the value of its second marking bit B2 (step 602).

If the second marking bit B2 of the identified packet Pk is equal to the sampling value (e.g. 0), the measurement point MPi determines that the packet Pk is to be subjected to a sample measurement (step 603).

The measurement point MPi accordingly provides a sample performance parameter relating to the packet Pk, based on which the sample measurement may be provided (step 604). For example, at step 604 the measurement point MPi may provide a timestamp relating to the packet Pk, considering also the value of the first marking bit B1 upon which the alternate marking is implemented, as provided by chapter 3.3.2 of the above-mentioned RFC 8321 and as also described by EP3085019 in the name of the same Applicant.

Otherwise, if the second marking bit B2 of the packet Pk is equal to the non-sampling value (e.g. 1), the measurement point MPi determines that the packet is not to be subjected to a sample measurement (step 605), and accordingly does not generate any sample performance parameter relating thereto.

Irrespective of whether the packet Pk belongs to a point-to-point packet flow for which sample measurements are required (and then irrespective of whether steps 602-605 have been carried out or not on the packet Pk), the measurement point MPi preferably determines whether the packet Pk is to be considered for a multipoint measurement, again based on the value of its second marking bit B2 (step 606).

Specifically, if the second marking bit B2 is equal to the sampling value (e.g. 0), the measurement point MPi determines that the packet Pk has not to be considered for a multipoint measurement (step 607). The measurement point MPi then does not take further actions in connection with this packet Pk.

If, instead, the second marking bit B2 is equal to the non-sampling value (e.g. 1), the measurement point MPi determines that the packet Pk has to be considered for a multipoint measurement (step 608).

The measurement point MPi accordingly updates at least one cumulative performance parameter relating to the multipoint packet flow PF as a whole (step 609). For example, at step 609 the measurement point MPi may update a cumulative counter and/or a cumulative timestamp relating to the multipoint packet flow PF as a whole, considering also the value of the first marking bit B1 upon which the alternate marking is implemented, as provided by the above-mentioned RFC 8889 and as also described by EP3449602 in the name of the same Applicant.

The measurement point MPi then may send the value of at least one performance parameter to the management server (step 610), which will use it to provide a performance measurement. The at least one performance parameter sent at step 610 preferably comprises the value of the at least one cumulative performance parameter possibly updated at step 609 and, if any, the value of the sample performance parameter generated at step 604.

According to a preferred embodiment, step 610 is performed at the end of each marking period T as indicated by the switching of the value of the first marking bit B1. At the end of a certain marking period, the measurement point MPi preferably sends to the management server the value reached by the at least one cumulative performance parameter at the end of the marking period and the value(s) of the sample performance parameter(s) generated for the sample(s) detected during that marking period.

The management server will then use the at least one performance parameter received from the measurement point(s) of the monitoring network for providing at least one performance measurement.

Specifically, if sample performance parameters are received from one or more measurement points located on the path of a point-to-point packet flow of the multipoint packet flow PF, they may be used to provide at least one sample measurement relating to that point-to-point packet flow, such as one-way delay or jitter of its sample packets. The at least one sample measurement may comprise for example a delay measurement as provided by chapter 3.3.2 of the above-mentioned RFC 8321 and as also described by EP3085019 in the name of the same Applicant; and/or a measurement of the delay variation (jitter), as provided by chapter 3.4 of the above-mentioned RFC 8321 and also described by EP3085019 in the name of the same Applicant.

Besides, the at least one cumulative performance parameter received from the input measurement points and output measurement points of the cluster may be used to provide at least one multipoint performance measurement, such as a multipoint packet loss measurement or a multipoint average delay measurement. For example, the multipoint performance measurement may comprise a multipoint packet loss measurement and/or a multipoint average delay measurement as provided by the above-mentioned RFC 8889 and as also described by EP3449602 in the name of the same Applicant.

Therefore, the packets Pk to be individually subjected to the sample measurement and the packets Pk to be considered for the multipoint measurement are identified based on different values of the same bit, namely the second marking bit B2. Hence, the packets Pk to be considered for the multipoint measurement are identified without applying any address filtering technique and without requiring any additional bit dedicated for this purpose. Since the second marking bit B2 merges two separate functions, two bits B1, B2 only are needed to support all the requested performance measurements based on alternate marking, namely the sample measurement (for example, a delay or jitter measurement as provided by RFC 8321) and the multipoint measurement (for example, the multipoint measurement as provided by RFC 8889).

It shall be noticed that, in general, in order to perform a sample measurement on a point-to-point packet flow, few packets are needed, typically one per marking period T at most. Hence, even assuming that sample measurements are required on all the point-to-point packet flows PF1, PF2, . . . . PF5 of the multipoint packet flow PF, the large majority of the packets of the multipoint packet PF flow still have their second marking bit B2 set equal to the non-sampling value. This advantageously results in the multipoint measurement being based on the large majority of the packets of the multipoint packet flow PF. An accurate multipoint measurement may accordingly be provided.

According to an advantageous variant, in order to determine whether a packet Pk has to be considered for the multipoint measurement, the measurement point MPi considers the values of both the marking bits B1 and B2.

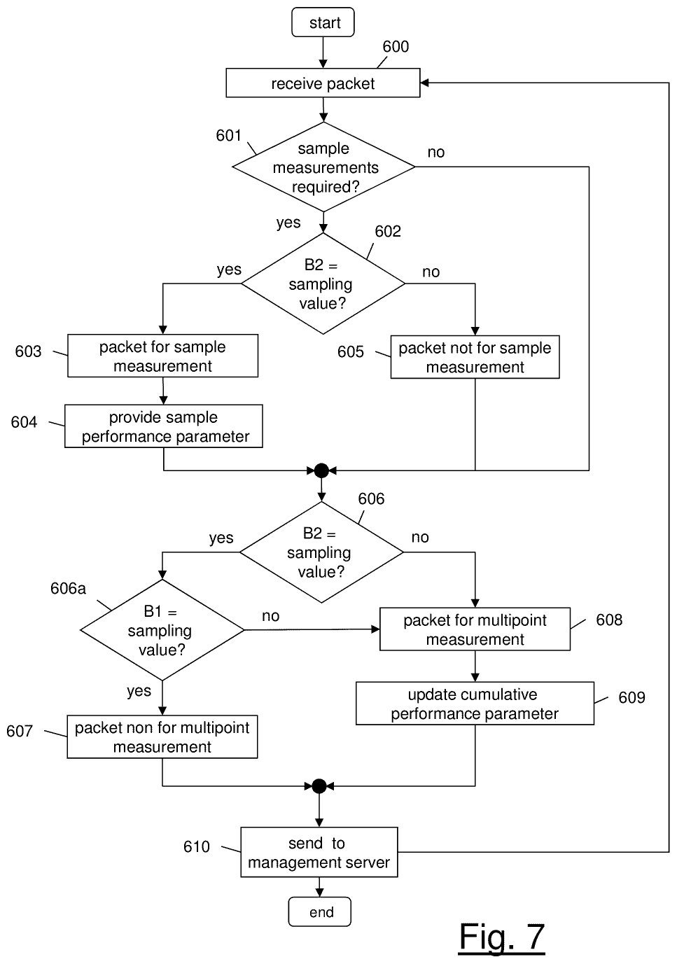

Specifically, with reference to the flow chart of FIG. 7, steps 600-605 are identical to steps 600-605 of the flow chart of FIG. 6. Hence, a detailed description of such steps will not be repeated.

As in the flow chart of FIG. 6, also according to the variant of FIG. 7 the measurement point MPi preferably determines whether the packet Pk is to be considered for a multipoint measurement, by firstly considering the value of its second marking bit B2 (step 606).

If the second marking bit B2 is equal to the sampling value (e.g. 0), according to this variant the measurement point MPi reads the value of first marking bit B1 (step 606a). If the first marking bit B1 is also equal to the sampling value (e.g. 0), the measurement point MPi concludes that the packet Pk has not to be considered for the multipoint measurement (step 607).

If, instead, the first marking bit B1 is equal to the non-sampling value (e.g. 1), the measurement point MPi concludes that the packet Pk has to be considered for the multipoint measurement (step 608). Similarly to the flow chart of FIG. 6, the measurement point MPi comes to the same conclusion also if the second marking bit B2 is equal to the non-sampling value (step 608). In this case, the measurement point MPi does not need to read the value of the first marking bit B1. The measurement point MPi then updates at least one cumulative performance parameter relating to the multipoint packet flow PF as a whole as described above (step 609).

The measurement point MPi then sends the value of at least one performance parameter to the management server (step 610), which will use it to provide a performance measurement, as described above in connection with the flow chart of FIG. 6.

Hence, according to this variant, the measurement point MPi considers for the multipoint measurement not only the packets Pk whose second marking bit B2 is equal to the non-sampling value, but also packets Pk whose second marking bit B2 is equal to the sampling value, provided they have their first marking bit B1 equal to the non-sampling value (e.g. 1). Hence, only packets Pk having both the first marking bit B1 and the second marking bit B2 equal to the sampling value (e.g. 0) are excluded from the multipoint measurement.

With reference for example to the marking scheme of FIG. 5, according to this advantageous variant only the first packet of the block BL2 and the first packet of the block BL4 having both the first bit B1 and second bit B2 equal to the sampling value 0 are excluded from the multipoint measurement. This advantageously results in the multipoint measurement being performed on a still larger portion of the packets Pk of the multipoint packet flow PF and, therefore, in an even more accurate measurement.

According to another embodiment, in the packets Pk of each point-to-point packet flow PF1, PF2, . . . . PF5 on which sample measurements are required, the second marking bit B2 is preferably set to the non-sampling value (e.g. 1) for all the packets Pk, with the following exception: only for marking periods T during which the first marking bit B1 is equal to the non-sampling value (e.g. 1), the second marking bit B2 of one packet Pk is set equal to the sampling value (e.g. 0). For marking periods T during which the first marking bit B1 is equal to the sampling value (e.g. 0), the second bit B2 is instead set to the non-sampling value (e.g. 1) for all the packets Pk. Preferably, only one packet Pk per marking period T during which the first marking bit B1 is equal to the non-sampling value (e.g. 1) has its second bit B2 set to the sampling value. According to some variants, however, two or more packets Pk per sampling period T during which the first marking bit B1 is equal to the non-sampling value (e.g. 1) may have their second bit B2 set to the sampling value.

FIG. 8 schematically shows the values of the first marking bit B1 and second marking bit B2 in the packets of a point-to-point packet flow comprised in the multipoint packet flow PF for which sample measurements are required, according to this embodiment of the present invention.

The first marking bit B1 is periodically switched with a marking period T between 1 and 0, so as to implement an alternate marking technique whereby traffic is divided into alternate blocks BL1, BL2, BL3, BL4, . . . of duration T, as provided by both the RFC 8321 and the RFC 8889. The second bit B2 is equal to the non-sampling value 1 for all the packets Pk, except for one packet for each marking period during which the first marking bit B1 is equal to the non-sampling value 1. For those packets only, the second marking bit B2 is equal to the sampling value 0. For marking periods during which the first bit B1 is equal to the sampling value 0, all the packets Pk have their second marking bit B2 set equal to the non-sampling value 1. As it may be seen in FIG. 8, therefore, the first and third blocks BL1, BL3 are made of packets with their first marking bit B1 equal to the non-sampling value 1, and hence one packet for each one of them (the first one, by way of non-limiting example) has the second marking bit B2 set to the sampling value 0. As to the second and fourth blocks BL2 and BL4, instead, the packets Pk comprised therein have their first marking bit B1 equal to the sampling value 0. Accordingly, all the packets Pk of these blocks have their second marking bit B2 fixedly set equal to the non-sampling value 1.

It may be appreciated that the marking scheme according to the embodiment of FIG. 8 further increases the number of packets Pk considered for the multipoint measurements, both when the measurement points MPi operate according to the flow chart of FIG. 6 and when the measurement points MPi operate according to the flow chart of FIG. 7.

By applying the flow chart of FIG. 6 to the marking scheme of FIG. 8, indeed, the packets Pk with their second marking bit B2 equal to the sampling value are identified as packets to be subjected to sample measurement, while the packets Pk with their second marking bit B2 equal to the non-sampling value are identified as packets to be considered for the multipoint measurement. In comparison with the marking scheme of FIG. 5, this results in a halving of the number of packets Pk subjected to sample measurement but, on the other hand, in an increased number of packets considered for the multipoint measurement. While indeed with the marking scheme of FIG. 5 one packet Pk per marking period T is ignored for the multipoint measurement, with the marking scheme of FIG. 8 one packet Pk for only half the marking periods T is ignored, namely those marking periods during which the first marking bit B1 is equal to the non-sampling value 1 (see first packet of block BL1 and first packet of block BL3). As to the other marking periods during which the first marking bit B1 is equal to the sampling value 0, all the packets Pk are considered for the multipoint measurement.

Moreover, by applying the flow chart of FIG. 7 to the marking scheme of FIG. 8, all the packets Pk are identified as packets to be considered for the multipoint measurement. The only packets Pk with their second marking bit B2 equal to the sampling value 0 indeed have their first marking bit B1 equal to the non-sampling value 1. This means that no packet Pk has both its marking bits B1 and B2 equal to the sampling value 0 and, hence, no packet is disregarded for the multipoint measurement. The resulting multipoint measurement is accordingly even more accurate.

The above operation of the measurement points MPi advantageously allows to provide different types of sample measurements and multipoint measurements over the multipoint packet flow Pf and its K point-to-point packet flows.

For example, with reference to the exemplary network 100 of FIG. 2, based on an input cumulative counter provided by the measurement point MP1 and output cumulative counters provided by the measurement points MP5, MP6, MP7 and MP8, a multipoint packet loss affecting the multipoint packet flow PF may be calculated as a difference between the input cumulative counter and the summation of the output cumulative counters, as described by EP3449602 in the name of the same Applicant. The commensurability of the input cumulative counter and output cumulative counters is guaranteed by the fact that the counters take into account only packets entering and leaving the monitoring network, which each measurement point MPi distinguishes from the packets originated within the monitoring network based on the value of the second marking bit B2 as described above (see flow chart of FIG. 6), optionally by taking into account also the value of the first marking bit B1 (see flow chart of FIG. 7).

Other multipoint measurements are possible. For example, if other measurement points are implemented at intermediate positions of the network 100, one or more clusters may be identified in the monitoring network, as described by EP3449602 in the name of the same Applicant. Multipoint measurements relating to each single cluster of the monitoring network may accordingly be provided.

As to the sample measurements, based on input timestamps provided by the measurement point MP1 for a sequence of samples identified in the point-to-point packet flow PF1 and output timestamps provided by the measurement point MP5 for the same samples, one-way delay measurements and/or jitter measurements for the point-to-point packet flow PF1 may be provided, as disclosed by EP3085019 in the name of the same Applicant. Similarly, based on input timestamps provided by the measurement point MP1 for a sequence of samples identified in the point-to-point packet flow PF3 and output timestamps provided by the measurement point MP6 for the same samples, one-way delay measurements and/or jitter measurements for the point-to-point packet flow PF3 may be provided, as disclosed by EP3085019 in the name of the same Applicant. The same applies also to the point-to-point packet flows PF2, PF4 and PF5.

In addition, of course, other types of performance measurements may be performed on the K point-to-point packet flows of the multipoint packet flow PF, such as packet loss measurements or average delay measurements. In order to support these types of measurements, the measurement point MPi only needs to identify the packets Pk of the point-to-point packet flow to be measured e.g. based on an ACL technique (see step 601 in FIGS. 6 and 7) and then read the value of its first marking bit B1, in order to identify the alternate blocks. For this type of measurements, there is instead no need to read also the second marking bit B2, which is dedicated to identification of the packets to be subjected to sample measurements and those to be considered for multipoint measurements.

According to further embodiments, sampling value and non-sampling value of the second marking bit B2 may be periodically inverted at each marking period T.

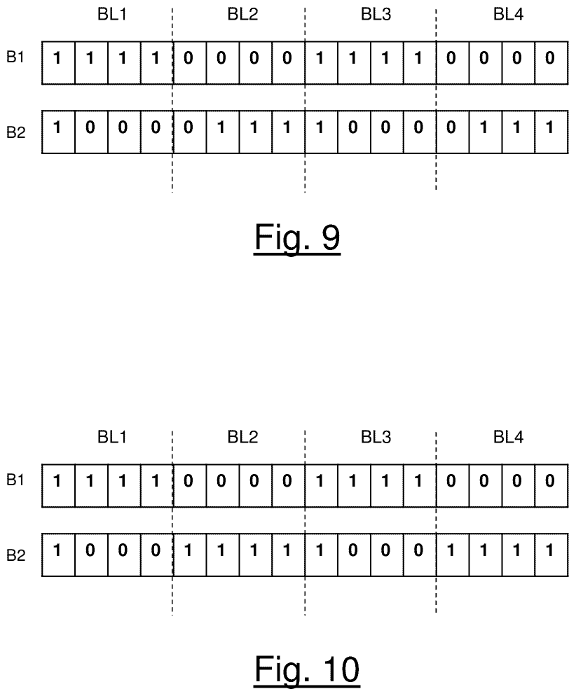

For example, as shown in FIG. 9, according to further embodiments the sampling value and non-sampling value of the second marking bit B2 may be periodically inverted at each marking period T so as to guarantee that, during each marking period T, the sampling value of the second marking bit B2 is equal to the current value of the first marking bit B1. As shown in FIG. 9, indeed, during the first and third marking periods (blocks BL1 and BL3) the value of the first marking bit B1 is 1 and, accordingly, the sampling value of the second marking bit B2 is also equal to 1, while the non-sampling value of the second marking bit B2 is equal to 0. During the second and fourth marking periods (blocks BL2 and BL4), instead, the value of the first marking bit B1 is 0 and, accordingly the sampling value of the second marking bit B2 is also equal to 0, while the non-sampling value of the second marking bit B2 is equal to 1.

According to these further embodiments, the second marking bit B2 may be set equal to the sampling value in one (or more) packets Pk for each marking period T, as shown in FIG. 9. Alternatively, as shown in FIG. 10, the second marking bit B2 may be set equal to the sampling value in one (or more) packets Pk for each marking period T having the first marking bit B1 equal to one of its values, e.g. 1, as shown in FIG. 10.

Also according to these variants, each measurement point MPi preferably identifies the packets Pk to be subjected to a sample measurement as those whose second marking bit B2 is equal to the sampling value, as shown in the flow charts of FIGS. 6 and 7 and described above in connection with the marking schemes of FIGS. 5 and 8. However, since the sampling value periodically changes at every marking period T, the measurement point MPi shall be capable of determining which is the current sampling value. For this purpose, the measurement point MPi may for example consider the current value of the first marking bit B1 and determine that the current sampling value is equal to the current value of the first marking bit B1.

This also applies to the identification of the packets Pk to be considered for the multipoint measurement. Each measurement point MPi indeed preferably identifies the packets Pk to be considered for the multipoint measurement as those whose second marking bit B2 is equal to the non-sampling value as shown in the flow chart of FIG. 6, possibly by also taking into account the value of the first marking bit B1 as shown in the flow chart of FIG. 7 and described above in connection with the marking schemes of FIGS. 5 and 8. However, since the non-sampling value periodically changes at every marking period T, the measurement point MPi shall be capable of determining which is the current non-sampling value. For this purpose, the measurement point MPi may for example consider the current value of the first marking bit B1, and determine that the current non-sampling value is other than the current value of the first marking bit B1.

1. A method for enabling a performance measurement on a multipoint packet flow carrying live traffic through a packet switched communication network, each packet of said multipoint packet flow comprising a first marking bit and a second marking bit, said method comprising:
a) before transmitting each packet of said multipoint packet flow through said network, alternately switching the value of said first marking bit between two alternative marking values; and setting said second marking bit to either a first value indicating that said packet is to be subjected to a sample performance measurement or a second value indicating that said packet is not to be subjected to said sample performance measurement; and
b) at at least one measurement point placed on the a path of said packet, reading said second marking bit and:
if said second marking bit is set to said first value, generating a sample performance parameter relating to said packet; and
if said second marking bit is set to said second value, updating a cumulative performance parameter relating to said multipoint packet flow as a whole.

2. The method according to claim 1, wherein at step a) said two alternative marking values are equal to said first value indicating that said packet is to be subjected to a sample performance measurement and said second value indicating that said packet is not to be subjected to said sample performance measurement.

3. The method according to claim 1, wherein at step a) said second marking bit is set equal to said first value indicating that said packet is to be subjected to a sample performance measurement in at least one packet of a point-to-point packet flow comprised in said multipoint packet flow, the other packets of said point-to-point packet flow having said second marking bit set equal to said second value indicating that said packet is not to be subjected to said sample performance measurement.

4. The method according to claim 3, wherein at step a) the method comprises, before transmitting each packet of the multipoint packet flow through the network, periodically switching the value of the first marking bit between two alternative marking values with a marking period.

5. The method according to claim 4, wherein at step a) said second marking bit is set equal to said first value indicating that said packet is to be subjected to a sample performance measurement in one packet of said point-to-point packet flow per marking period.

6. The method according to claim 4, wherein at step a) said second marking bit is set equal to said first value indicating that said packet is to be subjected to a sample performance measurement in one packet of said point-to-point packet flow per marking period, only if said first marking bit during said marking period is set equal to a predefined one of said two alternative marking values.

7. The method according to claim 6, wherein said predefined one of said two alternative marking values is equal to said second value indicating that said packet is not to be subjected to said sample performance measurement.

8. The method according to claim 1, wherein step b) comprises updating said cumulative performance parameter relating to said multipoint packet flow as a whole if said second marking bit is set to said first value indicating that said packet is to be subjected to a sample performance measurement and said first marking bit is equal to said second value indicating that said packet is not to be subjected to said sample performance measurement.

9. The method according to claim 4, further comprising exchanging said first value indicating that said packet is to be subjected to a sample performance measurement and said second value indicating that said packet is not to be subjected to said sample performance measurement periodically according to said marking period.

10. The method according to claim 1, wherein said sample performance parameter relating to said packet comprises a timestamp indicating a reception time of said packet at said at least one measurement point.

11. The method according to claim 1, wherein said cumulative performance parameter comprises a cumulative counter counting packets of said multipoint packet flow received at said at least one measurement point and/or a cumulative or average timestamp indicative a cumulative or average reception time of packets of said multipoint packet flow at said at least one measurement point.

12. The method according to claim 1, wherein at step b) said at least one measurement point determines whether said packet belongs to a point-to-point packet flow for which said sample performance measurement is required by applying an access command list technique.

13. The method according to claim 4, wherein at step a) said multipoint packet flow is injected in said network via at least two source nodes, said periodically switching the value of said first marking bit being performed by said at least two source nodes in a substantially synchronized way.

14. A method for performing a performance measurement in a packet-switched communication network, the method comprising the steps of the method for enabling a performance measurement according to claim 1, and further comprising:
c) performing a performance measurement including at least one of a sample measurement relating to said packet based on said sample performance parameter and a multipoint performance measurement based on said cumulative performance parameter.

15. The method according to claim 14, wherein step b) further comprises sending at least one of said sample performance parameter and cumulative performance parameter to a management server cooperating with said at least one measurement point, said step c) being performed by said management server.

16. A packet switched communication network supporting transmission of a multipoint packet flow carrying live traffic, each packet of said multipoint packet flow comprising a first marking bit and a second marking bit, said packet switched communication network comprising:
a) at least one node configured to, before transmitting each packet of said multipoint packet flow through said network, alternately switch the value of said first marking bit between two alternative marking values; and set said second marking bit to either a first value indicating that said packet is to be subjected to a sample performance measurement or a second value indicating that said packet is not to be subjected to said sample performance measurement; and
b) at least one measurement point placed on a path of said packet, said at least one measurement point being configured to read said second marking bit and:
if said second marking bit is set to said first value, generate a sample performance parameter relating to said packet; and
if said second marking bit is set to said second value, update a cumulative performance parameter relating to said multipoint packet flow as a whole.

17. A packet switched communication network according to claim 16, further comprising:
c) a management server configured to perform a performance measurement including at least one of a sample measurement relating to said packet based on said sample performance parameter and a multipoint performance measurement based on said cumulative performance parameter.
